(19) United States
(12) Patent Application Publication
(10) Pub. No.: US 2019/0213622 A1
(43) Pub. Date: Jul. 11, 2019

(54) SECURE AND REMOTE DYNAMIC REQUIREMENTS MATCHING

(71) Applicant: GREYDOG VENTURES LTD, Cambridge (GB)

(72) Inventors: Dominic J. Strowbridge, Cambridge (GB); Everhard N. Wrigley, Cambridge (GB); Laurence N. John, Cambridge (GB)

(73) Assignee: GREYDOG VENTURES LTD, Cambridge (GB)

(21) Appl. No.: 16/315,464

(22) PCT Filed: Jul. 26, 2017
(86) PCT No.: PCT/GB2017/052177

§ 371 Date: Jan. 4, 2019

(30) Foreign Application Priority Data
Jul. 27, 2016 (GB) 1613009.8

(51) Int. Cl. G06Q 30/02; G06F 21/53; G06Q 30/06

(52) U.S. Cl. CPC G06Q 30/0222; G06F 21/53; G06F 2221/2149; G06F 2221/2133; G06F 2221/2117; G06Q 30/0629

(57) ABSTRACT

A computer-implemented method of securely and dynamically generating requirements matches for a user, the method comprising a data matching platform remote and independent from one or more sources of requirements matches: receiving a user requirements match request message comprising a user identifier (ID); responsive thereto, transmitting a profile request message comprising the user ID to a secure profile server; responsive thereto, a secure computing environment of the data matching platform receiving profile data linked to the user ID from the secure profile server; receiving one or more matching rules from each of the one or more sources of requirements matches; and generating one or more requirements matches for the user within the secure computing environment in dependence on at least one of the matching rules and the profile data such that the profile data is shielded from the sources of requirements matches.

### FIELD

The present disclosure relates to secure generation of dynamic requirements matches by a data matching platform remote and independent from sources of requirements matches. Requirements matches may be provided to users via mobile user devices such as smartphones or tablets.

More specifically, an aspect relates to a computer-implemented method of securely and dynamically generating requirements matches for a user, a data matching platform, and a system comprising such a data matching platform and a secure profile server.

### BACKGROUND

Shopping around to obtain the best possible requirements match for goods or services can prove extremely arduous for users. When shopping online, they are often obliged to repeatedly provide personal data e.g. via forms on the websites of various different service providers, in order to be shown the requirements matches available to them from each provider. This can be time-consuming and the user may also have concerns about sharing their personal data in this way. They may even choose to avoid going through this process for sources of requirements matches they do not consider to be trustworthy guardians of their personal data (e.g. if they have not heard of a particular source, or if the source has recently had some bad press relating to a user data security breach). This can result in the user missing out on the best requirements matches.

Price comparison websites attempt to alleviate these problems by providing details of requirements matches from multiple sources in response to a single form entry. However, most price comparison websites do not represent the entire market, so the best requirements matches can still be missed. Further, when the sources of requirements matches themselves are not provided with the user's personal data, the price comparison website can only provide generic pre-published requirements matches, not the kind of dynamic requirements match which might be generated in real time when a user approaches a source of requirements matches directly.

Retailers have always been able to vary the prices or compositions of their goods and services to create dynamic requirements matches dependent on many factors, generally as a response to supply and demand. In traditional markets for example, the practice of haggling is common, where a retailer and a buyer will negotiate the price or composition of a requirements match face-to-face, on a one-on-one basis.

In the online world, the practice of providing dynamic requirements matches, using pricing as the differentiator, is also quite common. This is made possible by the rapid analysis of competitor pricing and product availability, plus the ability to segment users by multiple factors, including previous online behaviour and purchase history. For example, the airline industry is well known for increasing the price of flights to users who make searches but who do not buy on their first visit. The price of the same flight will be increased on subsequent visits, creating a sense of urgency in the user and helping the airline to maximise margin. Amazon is reputed to change the price of many of their products every day, based on competitor pricing, inventory levels and fluctuating demand.

Dynamic requirements matches are generally legal, as long as eligibility for the requirements match is not based on discriminatory criteria, such as nationality, race, religion, sexuality or gender. Users typically accept dynamic requirements matches based on their experience of supply and demand. For example, ticket touts are able to command highly inflated prices for events with very high demand, especially close to the start of the event. However, predatory requirements matches where, e.g. a retailer reduces prices below cost price with the aim of eliminating a competitor, are generally illegal.

Systems exist today that enable dynamic pricing with the objective of maximising margin for a retailer, e.g. Wiser.com. Such systems use web crawlers to analyse the pricing and inventory of competitor retailers. They then calculate the optimal pricing for the retailer to maximise conversion and profit. Such systems do not have access to user personal data however, and therefore make the same dynamically priced requirements matches to all users.

Other systems have access to detailed, proprietary profiles on users and are therefore able to make dynamic requirements matches on an individual basis. For example, Amazon stores very detailed profiles on its users so, by combining this with competitor pricing and inventory information, they are able to vary the prices that individual users see. Similarly, Tesco uses detailed proprietary profiles to make dynamic requirements matches to their customers, often in the form of money-off vouchers. The proprietary profiles used in these cases are not available for use by other retailers and the user has no control over how their profiles are being used.

Another problem with profiles that are not controlled by the person they relate to is that the profiles can be interpreted incorrectly. This is often the case with the profiles created by the advertising industry, which have detailed records of individuals' online behaviour but often interpret this incorrectly, resulting in irrelevant requirements matches being shown to those individuals.

There is growing concern amongst users that their personal data, held in profiles that they do not control, is being used against them.

Further, some systems can be gamed. For example, affiliate networks that distribute products to myriad online stores are often gamed by less scrupulous retailers, who flood the systems with multiple similar deals so that they can crowd out competitors. Safeguards need to be built into systems to prevent such gaming.

What is needed is a method of securely and dynamically generating requirements matches for a user.

### SUMMARY

According to a first aspect, there is provided a computer-implemented method of securely and dynamically generating requirements matches for a user, the method comprising a data matching platform remote and independent from one or more sources of requirements matches: receiving a user requirements match request message comprising a user identifier (ID); responsive thereto, transmitting a profile request message comprising the user ID to a secure profile server; responsive thereto, a secure computing environment of the data matching platform receiving profile data linked to the user ID from the secure profile server; receiving one or more matching rules from each of the one or more sources of requirements matches; and generating one or more requirements matches for the user within the secure computing environment in dependence on at least one of the matching rules and the profile data such that the profile data is shielded from the sources of requirements matches.

The secure computing environment can be a sandbox.

The profile data linked to the user ID can be received from the secure profile server in an encrypted message.

The method can further comprise the data matching platform receiving one or more base requirements matches from one or more of the sources of requirements matches; wherein at least one of the requirements matches generated within the secure computing environment can be generated by modifying one of the base requirements matches in dependence on at least one of the matching rules.

The requirements match request message can comprise contextual data relating to the context in which the user requirements match request message was sent.

The contextual data can comprise one or more of: data provided by the user in response to a query, user verification data, current user context data such as one or more of location, local time and local date, and user interface application type.

The method can further comprise the data matching platform providing results details of the one or more requirements matches to a user interface device accessible by the user.

The method can further comprise, responsive to providing the results details of the one or more requirements matches, the data matching platform receiving an indication from a user interface device that the user has selected one of the one or more requirements matches.

The method can further comprise, responsive to receiving the indication, the data matching platform transmitting a respective selection report to one or more of the one or more sources of requirements matches, the selection report indicating whether the respective source of requirements matches' requirements match was selected by the user.

The selection report can comprise report details of the requirements match selected by the user.

The results details can be provided in an order determined by the data matching platform according to a predetermined algorithm; the method further comprising: the data matching platform transmitting a respective results positioning report to one or more of the one or more sources of requirements matches, the results positioning report indicating the ranking of the respective source of requirements matches' requirements match in the order and the total number of requirements matches provided to the user interface device.

The selection report and the results positioning report can be transmitted together in a single message.

The method can further comprise the data matching platform: receiving a requirements match modelling request from one of the sources of requirements matches; determining a requirements match performance prediction based on historical data relating to the generated requirements matches; and providing the requirements match performance prediction to the source of requirements matches.

The method can further comprise the data matching platform: receiving a requirements match improvement query from one of the sources of requirements matches; generating a suggested requirement match amendment based on historical data relating to the generated requirements matches; and providing the suggested requirements match amendment to the source of requirements matches.

The matching rules can be configured to be used in generating the one or more requirements matches for a predetermined time period.

Following expiry of that predetermined time period, the secure computing environment of the data matching platform can be configured to generate the one or more requirements matches in dependence on one or more updated matching rules received from one or more of the one or more sources of requirements matches.

The method can further comprise the data matching platform filtering the one or more matching rules in dependence on predetermined anti-gaming and/or anti-discrimination criteria, such that only matching rules which meet all of these criteria are used to generate the one or more requirements matches.

The data matching platform can be configured to generate no more than a predetermined maximum number of requirements matches associated with each source of requirements matches.

The method can further comprise the secure profile server: receiving a profile update request comprising the user ID from a user interface device accessible by the user; verifying the user's identity; and updating profile data linked to the user ID according to the profile update request.

According to a second aspect there is provided a data matching platform comprising a memory in communication with a processor, the memory storing instructions which, on execution by the processor, cause the data matching platform to perform the method of the first aspect.

According to a third aspect there is provided a system comprising: the data matching platform of the second aspect; and a secure profile server comprising a memory in communication with a processor, the memory storing instructions which, on execution by the processor, cause the secure profile server to receive a profile update request comprising the user ID from a user interface device accessible by the user; verify the user's identity; and update profile data linked to the user ID according to the profile update request.

According to a fourth aspect there is provided a computer-implemented method of securely and dynamically generating requirements matches for a user, the method comprising a data matching platform remote and independent from one or more sources of requirements matches: receiving one or more matching rules from each of the one or more sources of requirements matches; and generating one or more requirements matches for the user within a secure computing environment in dependence on at least one of the matching rules.

### DESCRIPTION OF THE FIGURES

Aspects of the present disclosure will now be described by way of example with reference to the accompanying figures. In the figures:

FIG. 1 schematically illustrates an example system comprising a data matching platform;

FIG. 2 is a flowchart illustrating an example method of securely and dynamically generating requirements matches for a user;

FIGS. 3A, 3B, 3C and 3D illustrate example graphical user interfaces (GUIs) which could be displayed on a user device when a user accesses a requirements match provision interface; and

FIGS. 4A and 4B illustrate example GUIs which could be displayed to sources of requirement matches.

### DETAILED DESCRIPTION

The following description is presented to enable any person skilled in the art to make and use the system, and is provided in the context of a particular application. Various modifications to the disclosed embodiments will be readily apparent to those skilled in the art.

A data matching platform will now be described. The data matching platform is remote and independent from one or more sources of requirements matches. The sources of requirements matches provide certain matching rules to the data matching platform. The data matching platform then uses those rules to securely generate dynamic requirements matches within a secure computing environment.

The requirements matches may be personalised to a particular user by generating the requirements matches, according to the matching rules, in dependence on one or both of contextual data concerning the circumstances of a request for requirements matches, and personal data stored in a user profile on a secure profile server to which the secure computing environment of the data matching platform has access. In the latter case, the secure computing environment acts to shield the user profile data from sources of requirements matches. The user profile could for example be generated, stored, secured and updated as described in applicant's co-pending Patent Cooperation Treaty application PCT/E P2016/051340.

Examples of criteria which could be included in matching rules for a mobile phone contract requirements match are:
user is accessing the data matching platform via a price comparison app (e.g. as opposed to a money advice website, and is thus more likely to be ready to make a purchase)—contextual data;
user is not a bot (e.g. a reCAPTCHA test has been passed)—contextual data;
user is currently a customer of the source of requirements matches—secure profile data;
user has paid their last three months' mobile phone bills on time (or some other pseudo-credit check)—secure profile data;
user uses less than 100 minutes of call time per month (or some other usage data criterion)—secure profile data;
user has been on their current contract for more than two years—secure profile data;
user is an organisation of fewer than 10 individuals (for the purposes of providing family/business requirements matches)—secure profile data;
user's home address has good coverage on the source of requirements matches' network—secure profile data; and
user's current location has good coverage on the source of requirements matches' network—contextual data (e.g. mined from a GPS receiver on the user device being used to access the requirements matches).

The user may not wish sources of requirements matches to have knowledge of the information required to determine whether criteria such as those above are met for that user. However, the sources of requirements matches may not wish to provide certain favourable requirements match terms to a user without knowing that the user meets certain criteria. This problem is solved by the requirements matches being generated in a secure computing environment to which the sources of requirements matches do not have access, but according to matching rules defined by the sources of requirements matches.

The matching rules can define criteria to be singular or additive; i.e. more than one criterion might need to be met for the matching rules to permit a particular requirements match to be made. Global matching rules could also be applied, for instance a particular requirements match might be defined with limited availability, so that it is no longer available either after a certain predetermined time, or once a predetermined number of users have purchased it.

Rules could be valid for only a predetermined time period set by the data matching platform or the source of requirements matches. The data matching platform could apply matching rules only within certain predetermined time windows, with no changes to the rules being permitted within those windows, in order to prevent gaming by the sources of requirements matches.

Matching rules could be filtered by the data matching platform according to predetermined criteria in order to prevent gaming and/or discrimination and/or anti-competitive practices. For example, matching rules targeting the current users of a particular provider could be blocked as anti-competitive. Matching rules involving protected characteristics such as race, gender or sexuality could also be prohibited. Rules involving criteria which could be used as proxies for discriminatory criteria could also be filtered. For example, while a secure user profile may store a user's postcode, a matching rule specifying that users having certain postcodes cannot be provided with a particular requirements match might be filtered out on the basis that such a rule could be used to discriminate against residents of a particular neighbourhood having a community made up largely of people of a particular race. In contrast, a rule specifying that only users living within a specified distance of a mast of the source of requirements matches' network (and thus enjoying good coverage on that network) might be permissible, even though this might also make use of postcode data.

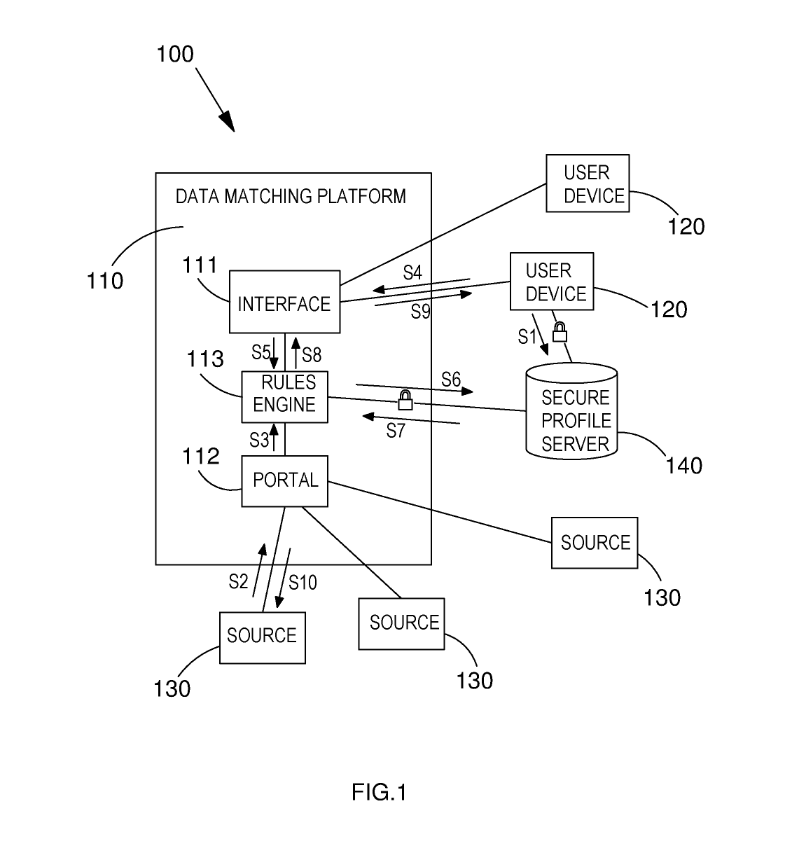

FIG. 1 schematically illustrates an example system 100 comprising a data matching platform 110. The data matching platform 110 is communicatively coupled to, but remote and independent from, both one or more user devices 120 and one or more sources of requirements matches 130. The data matching platform 110 can comprise a requirements match provision interface 111 communicatively coupled to the user devices 120. A partner portal 112, communicatively coupled to the sources of requirements matches, can also be comprised in the data matching platform. Both the requirements match provision interface 111 and the partner portal 112 can be communicatively coupled to a matching rules engine 113 further comprised in the data matching platform 110.

Each of the user devices 120 can be any user system for supporting electronic communications and interactions with a user. Examples of user devices 120 include mobile telephones, smart phones, laptop computers, tablets, desktop computers and other computing systems.

Each of the sources of requirements matches 130 can be a server/computing system capable of providing requirements matches. A transaction between a source of requirements matches and a user can occur if a requirements match is selected by a user.

One or more networks support electronic communication between the data matching platform 110, user devices 120 and sources of requirements matches 130. Such networks can comprise, for example, wired and/or wireless networks such as cellular telephone networks and the Internet. In addition to the nodes illustrated in FIG. 1, further relay nodes and/or base stations/access points may be provided. Some or all of the communications over these networks may be encrypted to enhance the security of the data transfer. Some or all of the communication could be via one or more application programming interfaces (APIs).

The matching rules engine 113 may also have secure (e.g. encrypted) access to a secure profile server 140 which can be comprised in the data matching platform, or external to it as shown in FIG. 1. The secure profile server 140 securely stores user profile data, which may be provided by one or more users over secure (e.g. encrypted) links with their user devices 120, as shown at S1. Once a user has set up a user profile on the secure profile server, they may be able to update that profile when desired, subject to verification of their identity, e.g. through a login process.

At S2, at least one source of requirements matches 130 transmits one or more matching rules to the data matching platform 110 via the partner portal 112. The rules are then passed to rules engine 113 at S3. The rules engine is then ready to generate requirements matches.

A user can then use their user device 120 to request requirements matches from the data matching platform 110 via the requirements match provision interface 111 at S4. The requirements match provision interface requests requirements matches from the rules engine 113 at S5.

The user request can comprise contextual data. Contextual data can include, for example, data provided by the user in response to a query (e.g. by filling in a form or moving a slider to indicate usage estimates). It can also include data inferred or derived from user-provided data (for example a risk factor derived from a postcode). Alternatively or additionally, user verification data could be included. For example, verification could be obtained via an account login process, and/or confirmation that the request originates from a human not a bot (e.g. confirmation of successful completion of a reCAPTCHA test). Data relating to the physical context of the request could be included, for example the current location of the user device used to make the request (e.g. as determined by a GPS receiver comprised in the device). Further, the interface method used to make the request could be included, e.g. web browser (optionally specifying the particular web page, e.g. using a uniform resource locator, URL), mobile app or virtual assistant (e.g. a virtual assistant incorporating speech recognition).

If the requirements matches request at S4 includes user identification data, then at S6 the rules engine 113 can request corresponding user profile data from the secure profile server 140. This can then be securely transmitted to the rules engine 113, which is run within a secure computing environment, such as a sandbox, shielded from the sources of requirements matches 130.

The matching rules engine 113 uses the provider matching rules received at S2 and S3 to generate one or more requirements matches, and provide these to the user's device 120 via the requirements match provision interface 111 at S8 and S9. Step S9 could for example be completed by refreshing a website or mobile app page, or by emailing or texting requirements match details to the user (in which case an email address or mobile telephone number could be obtained from the secure user profile).

Certain limitations might be applied by the data matching platform on what is provided to the user device. For example, while one source of requirements matches' rules might be configured such that a large number of different requirements matches can be made to one user, the requirements match provision interface 111 could be configured to only provide the user device 120 with a small predetermined number of requirements matches from each source of requirements matches, to avoid other providers being crowded out. For example, if requirements matches are to be displayed in a particular sort order according to a predetermined algorithm intended to rank requirements matches likely to be more attractive to the user higher than requirements matches likely to be less attractive to the user, only the top one or two requirements matches from that provider, in terms of that sort order, might be provided to the user.

The requirements matches can either be generated from scratch according to the matching rules set by a particular provider, or they can be generated by modifying base requirements matches (e.g. such as may be published on the website of the source of requirements matches, or on a price comparison website, without requiring any user login) according to the matching rules. Such base requirements matches can be provided together with the rules at S2.

Modification of base requirements matches could be to tailor the requirements match provided, for example to reduce a price or increase the quantity of a commodity (such as inclusive minutes in a mobile phone contract). Alternatively, it could be to hide particular details of the requirements match to be presented to the user. The form in which the modified requirements match is presented to the user could indicate that the full details can be revealed to them on fulfilment of some condition, for example providing some additional data. The data matching platform 110 can identify, based on the matching rules, which additional questions need to be asked of the user in order to ascertain this conditional requirements match can be revealed.

The requirements matches can be generated in dependence on contextual data and/or user profile data, for example received by the rules engine 113 as described above.

Feedback from the data matching platform 110 may also be provided to the sources of requirements matches 130 via the partner portal 112, as shown at S10. Such feedback can include, for example, data indicating the performance of a particular requirements match or a group of requirements matches generated in dependence on a particular matching rule or set of rules.

Performance of requirements matches can be determined, for example, in terms of ranking and/or selection rates and/or conversion rates. Rank refers to position in a presentation order. For example, the requirements match provision interface 111 may sort requirements matches by a particular criterion, such as price, by default, or may display requirements matches in an order determined by a more complex algorithm. Users might be able to change the sort order criteria. Selection rates (otherwise known as “click-through” rates) refer to the number of requirements matches the user chooses to investigate further. Conversion rates refer to the proportion of requirements matches or selections converted to actual sales.

Sources of requirements matches can determine useful information from such performance data. For example, performance of particular requirements matches can be used to inform development of future matching rules. Performance data can also indicate issues with the parts of the sales channel the source of requirements matches controls. For example, if the number of requirements match selections is high, but a low proportion of these selections result in conversion to sales, it can be inferred that the user interface users encounter on selecting a requirements match (clicking through) is unsatisfactory and should be improved.

Feedback to sources of requirements matches can also be in the form of predictions based on historical data, allowing the sources of requirements matches to model the effects of changes to their matching rules and/or base requirements matches. Feedback can be provided to the sources of requirements matches in real time to enable dynamic improvements to base requirements matches and/or matching rules. Alternatively, machine learning algorithms could be implemented to automatically update base requirements matches and/or matching rules, within bounds set by the sources of requirements matches, to improve the number and/or ranking of their requirements matches.

The historical data used could include performance data as described above. It could also include aggregated (and thus anonymised) data relating to criteria referred to in matching rules, and/or behavioural data.

The data matching platform could provide sources of requirements matches with requirements match improvement suggestions based on such modelling techniques. For example, a source of requirements matches could make a request indicating that they wish to improve a particular performance metric by at least a particular percentage. The data matching platform can then determine, based on historical data, one or more ways in which this goal can be achieved and provide them to the source of requirements matches.

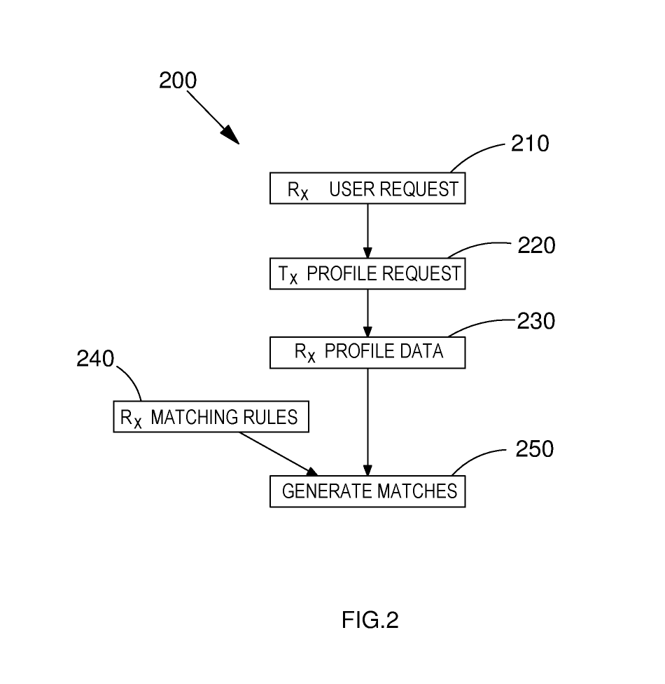

FIG. 2 is a flowchart illustrating an example method 200 of securely and dynamically generating requirements matches for a user. Such a method can be performed by a data matching platform remote and independent from one or more sources of requirements matches, for example as described in relation to FIG. 1 above.

At 210, the data matching platform receives a user requirements match request message comprising a user identifier (ID). Responsive thereto, at 220 the data matching platform transmits a profile request message comprising the user ID to a secure profile server. The secure profile server then transmits profile data to the data matching platform and at 230 a secure computing environment of the data matching platform receives that profile data. At some point before, during or after steps 210 to 230, at 240 the data matching platform receives one or more matching rules from each of the one or more sources of requirements matches. Finally, once all of steps 210 to 230 and 240 have been performed, the data matching platform at 250 generates one or more requirements matches for the user within the secure computing environment in dependence on at least one of the matching rules and the profile data, such that the profile data is shielded from the sources of requirements matches.

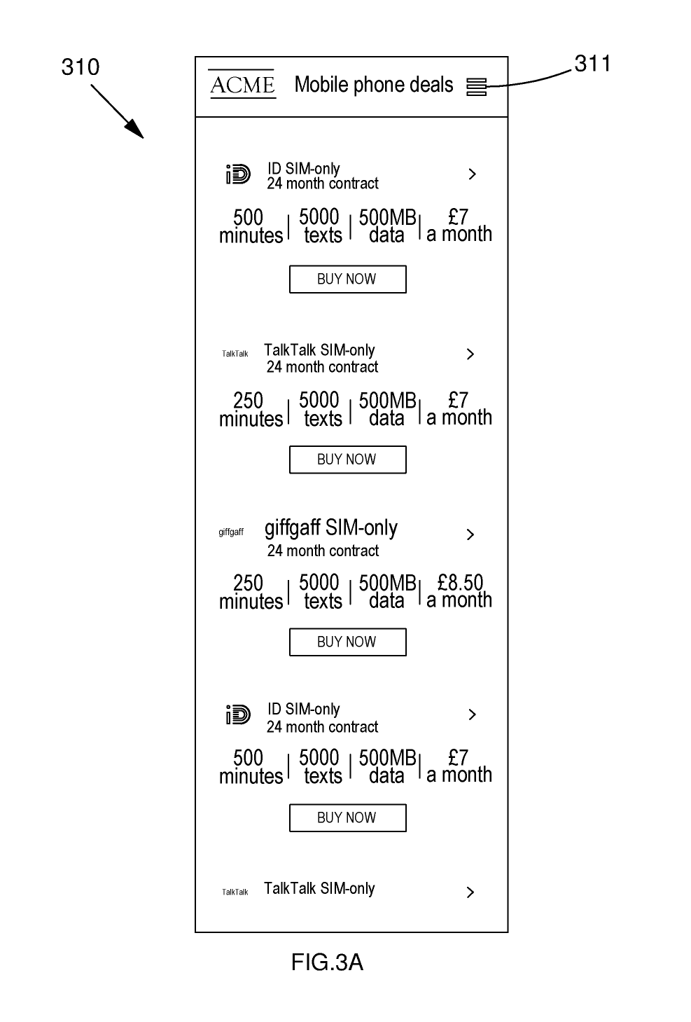

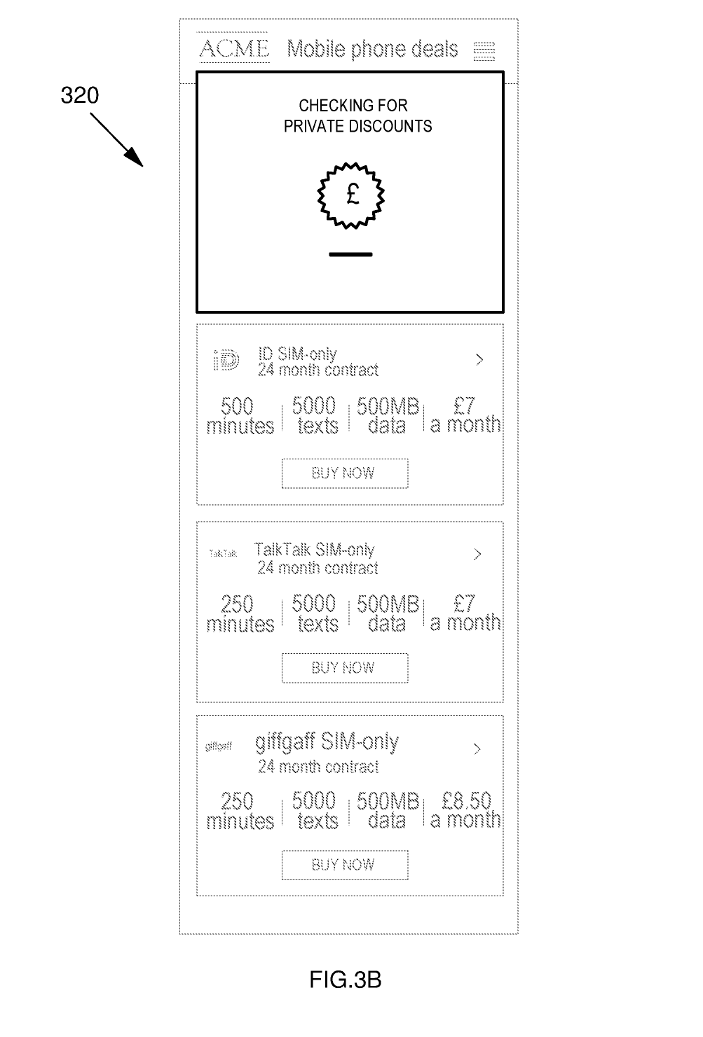

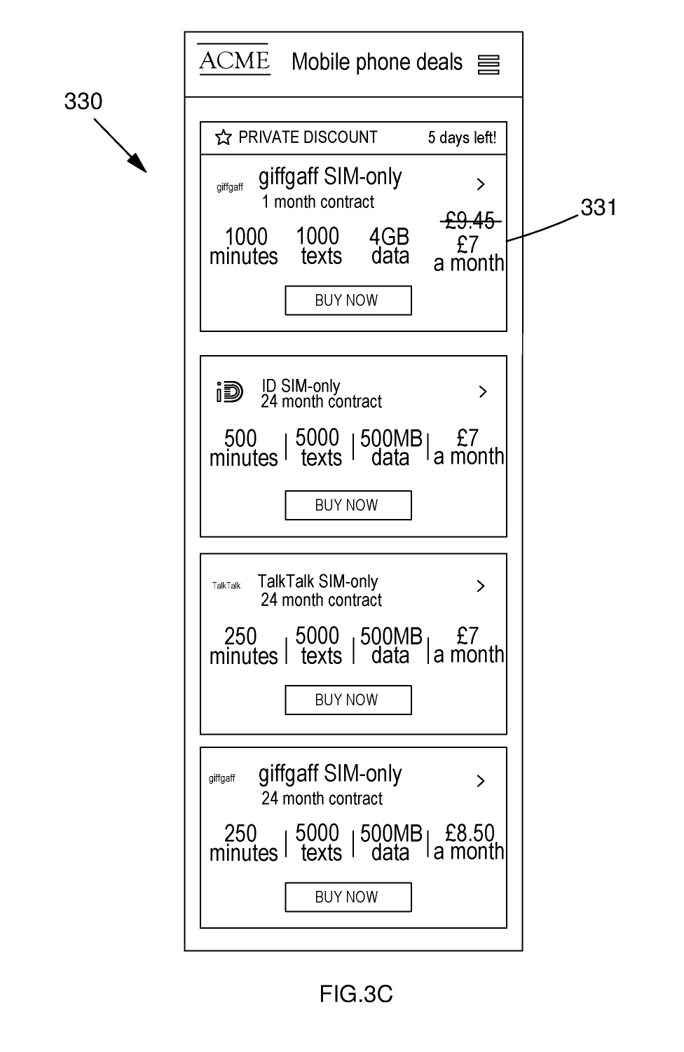

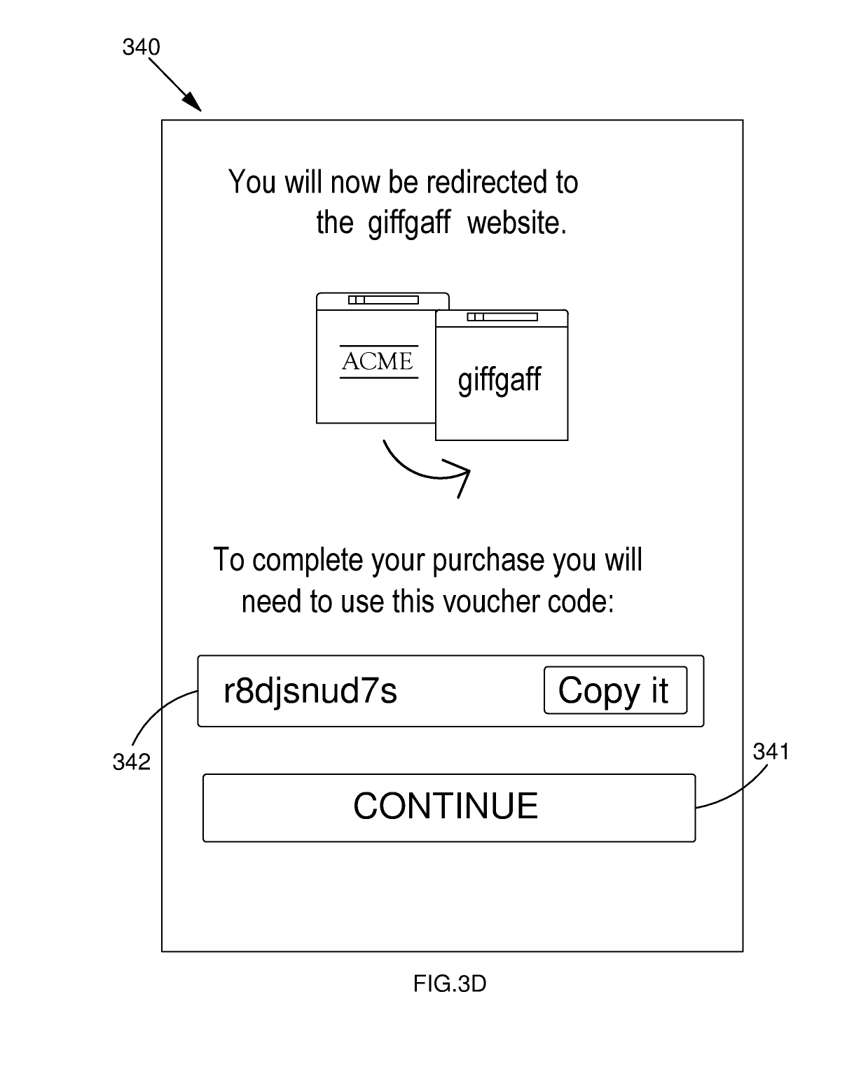

FIGS. 3A to 3D illustrate example graphical user interfaces (GUIs) which could be displayed on a user device when a user accesses a requirements match provision interface, e.g. through a website or mobile app. In this case, the requirements matches are for mobile phone contracts, though the methods and systems described herein can apply to many other kinds of requirements match.

The GUI 310 of FIG. 3A displays public requirements matches, such as might be displayed on a conventional price comparison site. For example, as shown each requirements match indicates the source, the contract length, the number of inclusive minutes, texts and data megabytes, and the price per month. If any of the requirements matches are limited, e.g. in terms of the time remaining before they expire or the total number available, the limitations could also be indicated here. Selection of icon 311 in the corner of the GUI 310 allows the user to change search parameters, for example by using a slider to specify filter values for details such as inclusive minutes, text messages and data. The user can also select an option to be provided with private requirements matches. This may be conditional on completing a verification/login process. For example, this could involve a reCAPTCHA test to confirm the user is a human not a bot, and/or a registration or login step. Verification/login may not be required if the GUI is being accessed through a particular trusted channel, such as a particular website or mobile app.

The requirements match provision interface could collect contextual data sufficient to establish whether any private requirements matches could be available to the user, without verification/login required. If such private requirements matches are potentially available, this can be indicated to the user to encourage them to authenticate themselves to the data matching platform in order to access the details of these requirements matches.

Once the private requirements match option has been selected and any verification/login procedure completed, GUI 320 of FIG. 3B is displayed to instruct the user to wait while the user device communicates with the data matching platform and obtains details of one or more requirements matches generated as a result.

Once any private requirements matches have been provided to the user device, it displays GUI 330 of FIG. 3C, where any private requirements matches generated by the data matching platform are displayed together with the previously displayed public requirements matches. As shown at 331, any private requirements matches provided could be highlighted to the user.

The number of private requirements matches displayed per user session could be limited in order to inhibit sources of requirements matches from reverse engineering competitor matching rules.

If the user selects one of the private requirements matches to investigate it further, they can be provided with GUI 340 of FIG. 3D. This allows the user to select a link 341 to redirect them to the source of requirements matches' website, and provides them with a requirements match code 342 to be entered on checking out to ensure they obtain the terms of the private requirements match if they make a purchase.

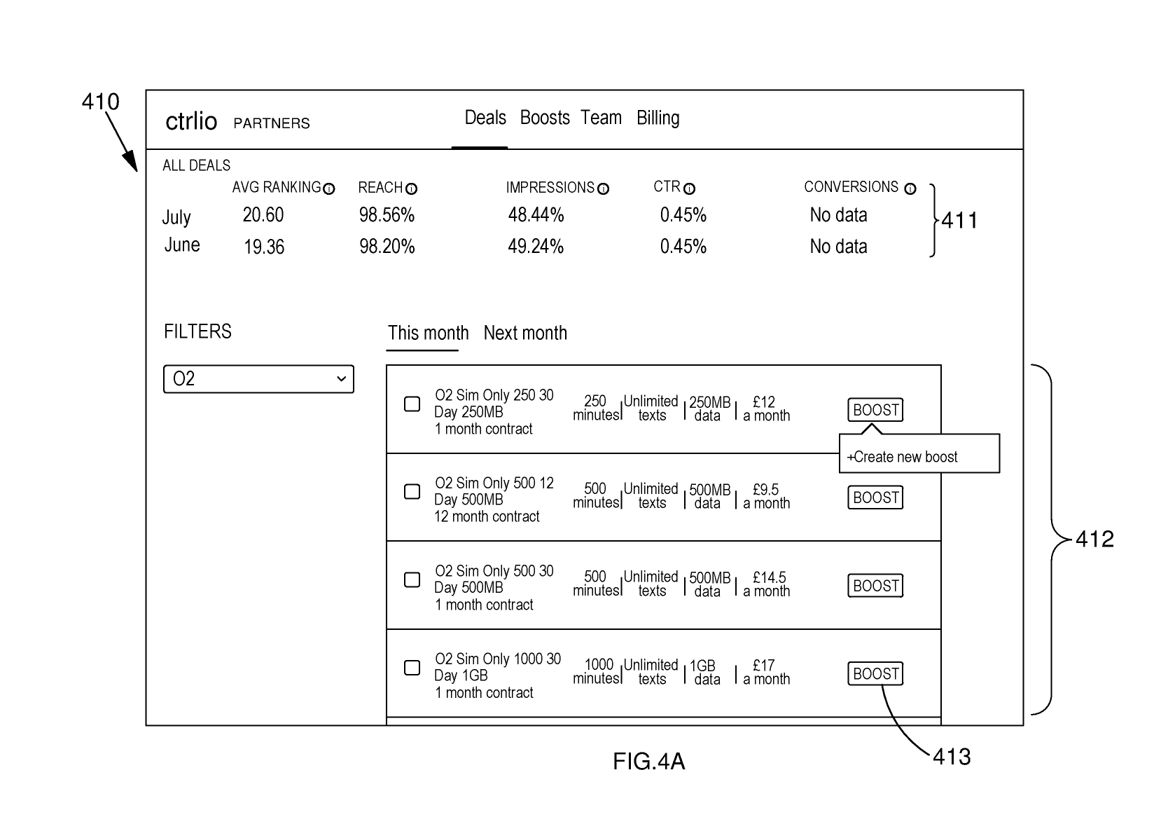

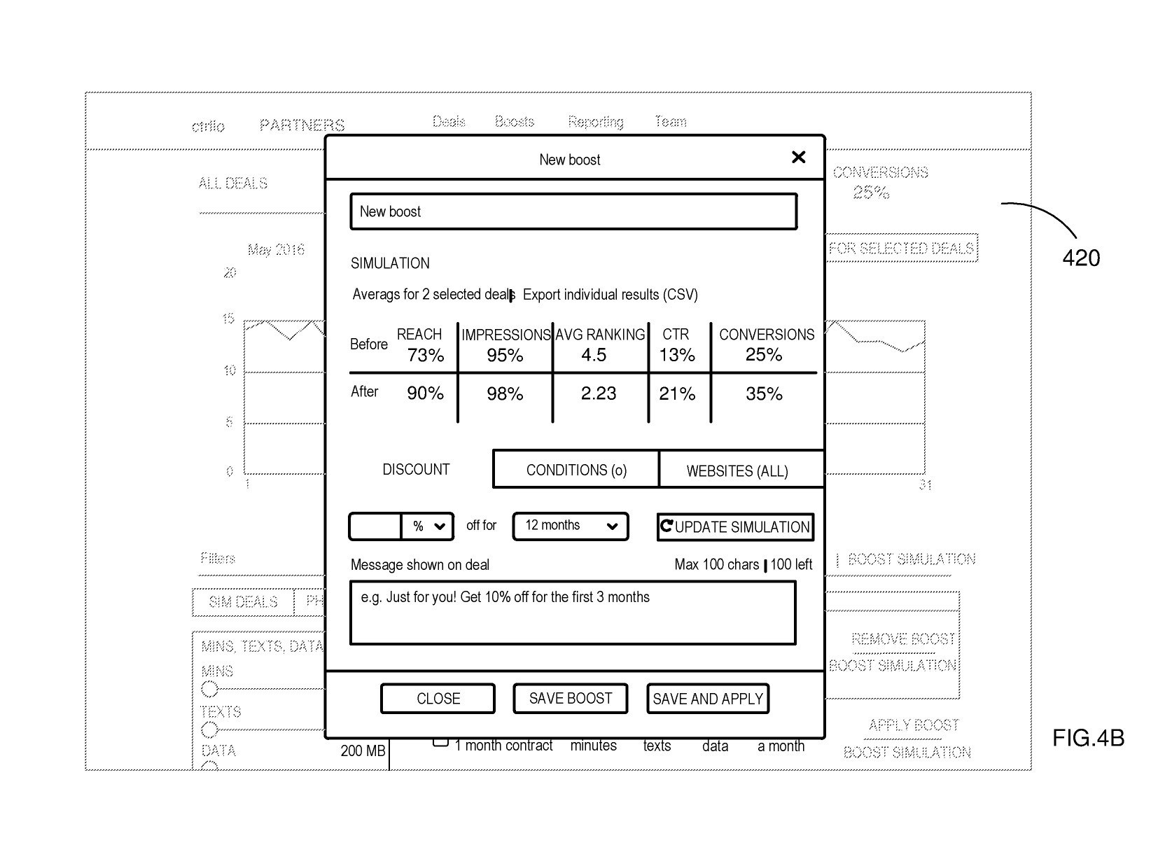

FIGS. 4A to 4B illustrate example GUIs which could be displayed to sources of requirement matches

GUI 410 of FIG. 4A provides the source of requirements matches with summary performance data 411 for past requirements matches made to users through the data matching platform. For example, as shown, data for the previous two months is shown to indicate average ranking (i.e. on average, how far down a requirements match list presented to a user that source of requirements matches' requirements matches are displayed), reach (i.e. how many registered users have indicated an interest in the source of requirements matches' goods/service class), impressions (i.e. the proportion of times that the source's requirements matches have featured in the top 5 results), CTR (i.e. the proportion of times that a source's requirements matches have been selected) and conversions (i.e. how many times click-throughs by users from the requirements matches provision interface resulted in sales).

A list 412 of their current base requirements matches is also provided. Each base requirements match is accompanied by a “boost” button 413 which the source of requirements matches can select to allow them to define matching rules for modifying the base requirements match.

GUI 420 of FIG. 4B is displayed if the source of requirements matches selects a “boost” button. This GUI allows the source of requirements matches to enter different parameters for the boost and see the results of simulations based on those parameters in terms of performance criteria. For example, a particular percentage discount can be applied for a particular duration of a mobile phone contract for users whose profile data indicates they meet certain conditions.

The data matching platform can use historical performance data to determine what aspects of the requirements matches that were successfully selected are most influential on successful selection, and enable the sources of requirements matches to create new base requirements matches that are more likely to match requirements accordingly.

Although in the above processes are described in which a user makes a request in order to trigger data matching, other triggers could be used. For example, if the user profile comprises data indicating that a contract they are signed up to for a particular service is due to expire within a predetermined time period (e.g. one month), this could trigger an email to the user listing various requirements matches generated as described above. Alternatively, update emails could be sent periodically, e.g. weekly or monthly.

Although a single data matching platform has been described herein supporting a plurality of user devices, a data matching platform may alternatively be designed to support only one user device. In this case, a data matching platform may be located with each user device and they may be sold as a combined unit.

Although the data matching platform has been described as comprising the analysis functionality to allow sources of requirements matches to track performance of their existing matching rules and simulate the performance of proposed future matching rules, this functionality could instead be provided by a separate performance simulation platform.

Although the examples provided herein relate to mobile phone contracts, the methods and systems described are applicable to many other types of requirements match. For example requirements matches could relate to any kind of commercial, collaborative or charitable enterprise e.g. relating to television, internet, landline telephone or utilities contracts, insurance, financial services, catering, travel, accommodation, human resources, taxi, cleaner, tradespeople, tutor or babysitter services or humanitarian aid, amongst many others. The methods described herein could be embodied in code provided in software development kits for adaptation to particular use cases.

While the example interfaces provided are GUIs, the user and/or sources of requirements matches could interact with the data matching platform through other kinds of interfaces, for example using speech recognition and/or speech generation, e.g. provided by a virtual assistant.

The methods and systems described above improve the security of a user's personal data. The inputs to the secure computing environment are data and algorithms from sources of requirements matches and personal data of a user. The output from the secure computing environment is a result of the matching that does not comprise the personal data. Advantageously, no personal data of the user is ever provided to the sources of requirements matches.

Other embodiments will be apparent to those skilled in the art from consideration of the specification and practice of the embodiments disclosed herein. It is intended that the specification and examples be considered as exemplary only.

In addition, where this application has listed the steps of a method or procedure in a specific order, it could be possible, or even expedient in certain circumstances, to change the order in which some steps are performed, and it is intended that the particular steps of the method or procedure claims set forth herein not be construed as being order-specific unless such order specificity is expressly stated in the claim. That is, the operations/steps may be performed in any order, unless otherwise specified, and embodiments may include additional or fewer operations/steps than those disclosed herein. It is further contemplated that executing or performing a particular operation/step before, contemporaneously with, or after another operation is in accordance with the described embodiments.

The methods described herein may be encoded as executable instructions embodied in a computer readable medium, including, without limitation, non-transitory computer-readable storage, a storage device, and/or a memory device. Such instructions, when executed by a processor (or one or more computers, processors, and/or other devices) cause the processor (the one or more computers, processors, and/or other devices) to perform at least a portion of the methods described herein. A non-transitory computer-readable storage medium includes, but is not limited to, volatile memory, non-volatile memory, magnetic and optical storage devices such as disk drives, magnetic tape, compact discs (CDs), digital versatile discs (DVDs), or other media that are capable of storing code and/or data.

Where a processor is referred to herein, this is to be understood to refer to a single processor or multiple processors operably connected to one another. Similarly, where a memory is referred to herein, this is to be understood to refer to a single memory or multiple memories operably connected to one another.

The methods and processes can also be partially or fully embodied in hardware modules or apparatuses or firmware, so that when the hardware modules or apparatuses are activated, they perform the associated methods and processes.

1. A computer-implemented method of securely and dynamically generating requirements matches for a user, the method performed by a data matching platform remote and independent from one or more sources of requirements matches, the method comprising:
receiving a user requirements match request message comprising a user identifier, ‘ID’;
responsive thereto, transmitting a profile request message comprising the user ID to a secure profile server;
responsive thereto, a secure computing environment of the data matching platform receiving profile data linked to the user ID from the secure profile server;
receiving one or more matching rules from each of the one or more sources of requirements matches, each matching rule including one or more criteria; and
generating one or more requirements matches for the user in dependence on at least one of the matching rules for which the profile data received by the secure computing environment meets the one or more criteria included in the respective at least one of the matching rules, wherein the requirements matches are generated within the secure computing environment such that the profile data is shielded from the sources of requirements matches.

2. The method of claim 1, wherein the secure computing environment is a sandbox.

3. The method of claim 1, wherein the profile data linked to the user ID is received from the secure profile server in an encrypted message.

4. The method of claim 1, wherein:
the requirements match request message comprises contextual data relating to the context in which the user requirements match request message was sent;
the contextual data optionally comprising one or more of: data provided by the user in response to a query, user verification data, current user context data such as one or more of location, local time and local date, and user interface application type.

5. The method of claim 1, further comprising the data matching platform providing results details of the one or more requirements matches to a user interface device accessible by the user.

6. The method of claim 5, further comprising, responsive to providing the results details of the one or more requirements matches, the data matching platform receiving an indication from a user interface device that the user has selected one of the one or more requirements matches.

7. The method of claim 6, further comprising, responsive to receiving the indication, the data matching platform transmitting a respective selection report to one or more of the one or more sources of requirements matches, the selection report indicating whether the respective source of requirements matches' requirements match was selected by the user.

8. The method of claim 7, wherein the selection report comprises report details of the requirements match selected by the user.

9. The method of claim 5, wherein:
the results details are provided in an order determined by the data matching platform according to a predetermined algorithm;
the method further comprising:
the data matching platform transmitting a respective results positioning report to one or more of the one or more sources of requirements matches, the results positioning report indicating the ranking of the respective source of requirements matches' requirements match in the order and the total number of requirements matches provided to the user interface device.

10. The method of claim 9, further comprising:
Responsive to providing the results details of the one or more requirements matches, the data matching platform receiving an indication from a user interface device that the user has selected one of the one or more requirements matches;
Transmitting a respective selection report to one or more of the one or more sources of requirements matches, the selection report indicating whether the respective source of requirements matches' requirements match was selected by the user; wherein the selection report and the results positioning report are transmitted together in a single message.

11. The method of claim 1, further comprising the data matching platform:
receiving a requirements match modelling request from one of the sources of requirements matches;
determining a requirements match performance prediction based on historical data relating to the generated requirements matches; and
providing the requirements match performance prediction to the source of requirements matches.

12. The method of claim 1, wherein:
the matching rules are configured to be used in generating the one or more requirements matches for a predetermined time period; and
following expiry of that predetermined time period, the secure computing environment of the data matching platform is optionally configured to generate the one or more requirements matches in dependence on one or more updated matching rules received from one or more of the one or more sources of requirements matches.

13. The method of claim 1, further comprising the secure profile server:
receiving a profile update request comprising the user ID from a user interface device accessible by the user;
verifying the user's identity; and
updating profile data linked to the user ID according to the profile update request.

14. A data matching platform comprising a memory in communication with a processor, the memory storing instructions which, on execution by the processor, cause the data matching platform to perform a method comprising:
receiving a user requirements match request message comprising a user identifier, ‘ID’;
responsive thereto, transmitting a profile request message comprising the user ID to a secure profile server;
responsive thereto, a secure computing environment of the data matching platform receiving profile data linked to the user ID from the secure profile server;
receiving one or more matching rules from each of the one or more sources of requirements matches, each matching rule including one or more criteria; and
generating one or more requirements matches for the user in dependence on at least one of the matching rules for which the profile data received by the secure computing environment meets the one or more criteria included in the respective at least one of the matching rules, wherein the requirements matches are generated within the secure computing environment such that the profile data is shielded from the sources of requirements matches.

15. A system comprising:
a data matching platform, the data matching platform configured to
receive a user requirements match request message comprising a user identifier, ‘ID’;
responsive thereto, transmit a profile request message comprising the user ID to a secure profile server;
responsive thereto, a secure computing environment of the data matching platform receiving profile data linked to the user ID from the secure profile server;
receive one or more matching rules from each of the one or more sources of requirements matches, each matching rule including one or more criteria; and
generate one or more requirements matches for the user in dependence on at least one of the matching rules for which the profile data received by the secure computing environment meets the one or more criteria included in the respective at least one of the matching rules, wherein the requirements matches are generated within the secure computing environment such that the profile data is shielded from the sources of requirements matches; and
a secure profile server in communication with the data matching platform and operable to
receive a profile update request comprising the user ID from a user interface device accessible by the user;
verify the user's identity; and
update profile data linked to the user ID according to the profile update request.
